(19) United States
(12) Patent Application Publication
(10) Pub. No.: US 2024/0002697 A1
(43) Pub. Date: Jan. 4, 2024

(54) POLISHING COMPOSITION AND POLISHING METHOD USING THE SAME

(71) Applicant: FUJIMI INCORPORATED, Aichi (JP)

(72) Inventor: Ryo Wakabayashi, Aichi (JP)

(73) Assignee: FUJIMI INCORPORATED, Aichi (JP)

(21) Appl. No.: 18/278,467

(22) PCT Filed: Jan. 26, 2022
(86) PCT No.: PCT/JP2022/002799

§ 371 Date: Aug. 23, 2023

(30) Foreign Application Priority Data
Mar. 3, 2021 (JP) 2021-033188

(51) Int. Cl. C09G 1/02

(52) U.S. Cl. CPC C09G 1/02

(57) ABSTRACT

The present invention is to provide a means for reducing residual abrasive grains on a surface of an object to be polished after polishing. The polishing composition of the present invention comprises abrasive grains and a dispersing medium, wherein the abrasive grains are silica particles having an average particle size (D₅₀) of more than 1.0 μm and a circularity of primary particles of 0.90 or more.

### TECHNICAL FIELD

The present invention relates to a polishing composition and a method using the same.

### BACKGROUND ART

Conventionally, various studies of polishing compositions for various materials including resins have been made.

Japanese Patent Laid-Open No. 2016-183212 discloses a polishing composition for an object to be polished containing a resin with high rigidity and high strength. More specifically, Japanese Patent Laid-Open No. 2016-183212 discloses that even a resin with high rigidity and high strength can be polished with a polishing composition containing abrasive grains having Mohs hardness and a surface acid level equal to or more than specified values, respectively, and a dispersing medium, at a high polishing rate. Further, Japanese Patent Laid-Open No. 2016-183212 also discloses that abrasive grains mainly composed of α-alumina are preferred from the viewpoint of polishing rate.

Japanese Patent Laid-Open No. 2007-063442 discloses a polishing composition for an object to be polished made of synthesized resin. More specifically, Japanese Patent Laid-Open No. 2007-063442 discloses that use of a polishing composition containing a polyurethane-based polymer surfactant with a specific structure and having a specific viscosity range, can prevent reduction polishing ability in polishing the synthesized resin. Further, Japanese Patent Laid-Open No. 2007-063442 also discloses that a polishing composition further containing α-alumina as abrasive grains is preferred from the viewpoint of polishing rate.

### SUMMARY OF INVENTION

However, there is still room for improvement of a polishing rate.

Accordingly, the present invention has been made in view of the circumstances. An object of the present invention is to provide means for improving a polishing rate of an object to be polished (in particular, an object to be polished containing a resin and a filler).

The present inventor has performed diligent study to solve the problem. As a result, the present inventor has found that the problem can be solved by using silica particles having a specific particle size and a specific circularity as abrasive grains, and thereby the present invention has been completed.

Specifically, the problem of the present invention can be solved by the following means:

A polishing composition including abrasive grains and a dispersing medium, wherein the abrasive grains are silica particles having an average particle size (D₅₀) of more than 1.0 μm and a circularity of primary particles of 0.90 or more.

Hereinafter, embodiments of the present invention will be described. The present invention is not limited only to the following embodiments, and various modifications can be made within the scope of the appended claims. Throughout the description, unless particularly stated otherwise, any expression in a singular form should be understood to encompass the concept of its plural form. Therefore, unless particularly stated otherwise, the article specifying a single form (for example, “a”, “an”, “the”, and the like in the case of English language) should be understood to encompass the concept of its plural form.

Further, unless particularly stated otherwise, any term used in the present description should be understood as a term that is used to have the meaning conventionally used in the relevant technical field. Therefore, unless defined otherwise, all the technical terms and scientific terms used in the present description have the same meaning as generally understood by a person ordinarily skilled in the art to which the present invention is pertained. If there is any conflict in meaning, the present description (including the definitions) takes priority.

In the present description, “X to Y” representing a range means “X or more and Y or less” including X and Y. Unless otherwise specified, operations and measurement of physical properties are performed under conditions at room temperature (in the range of 20° C. or more and 25° C. or less)/a relative humidity of 40% RH or more and 50% RH or less.

### Polishing Composition

An aspect of the present invention relates to a polishing composition comprising abrasive grains and a dispersing medium, wherein the abrasive grains are silica particles having an average particle size (D₅₀) of more than 1.0 μm and a circularity of primary particles of 0.90 or more. According to the present invention, a polishing rate of an object to be polished (in particular, an object to be polished containing a resin and a filler) can be improved. Use of the silica particles having a specific particle size and a specific circularity as defined herein as abrasive grains enables the polishing rate of an object to be polished (in particular, an object to be polished containing a resin and a filler) to be improved. The use of the silica particles enables residual abrasive grains on a surface of an object to be polished (in particular, an object to be polished containing a resin and a filler) to be reduced after polishing. In polishing of an object to be polished (in particular, an object to be polished containing a resin and a filler) , the use of the silica particles enables a good balance to be achieved between a high polishing rate and a less amount of residual abrasive grains on a surface thereof after being polished.

The polishing composition according to the present invention is supplied to an object to be polished typically in a form of a polishing liquid containing the polishing composition for use in polishing the object to be polished. The polishing composition according to the present invention may be, for example, diluted (typically with water) for use as polishing liquid, or directly used as polishing liquid. In other words, the concept of polishing composition in the technique related to the present invention includes both of a polishing composition which is supplied to an object to be polished for use in polishing the object to be polished (working slurry) and a concentrate which is diluted for use in polishing (concentrated liquid for working slurry). A concentration factor of the concentrate may be, for example, about 2 to 100 on volumetric basis, and an appropriate factor is usually about 5 to 50.

### Abrasive Grains

### Silica Particles

The abrasive grains contained in the polishing composition according to the present invention are silica particles having an average particle size (D₅₀) of more than 1.0 μm and a circularity of primary particles of 0.90 or more. In the present description, unless otherwise specified, silica particles having an average particle size (D₅₀) of more than 1.0 μm and a circularity of primary particles of 0.90 or more as abrasive grains are also referred to simply as “silica particles according to the present invention” or “silica particles”.

In an embodiment of the present invention, both of dry silica particles and wet silica particles are preferably used as the silica particles. Silica particles may be easily produced with appropriate reference to a known production method. Alternatively, as long as silica particles satisfy the average particle size (D₅₀) and the circularity of primary particles as defined in the present invention, a commercially available product may be used. Examples of the production method of dry silica particles may include a flame hydrolysis method, a vaporized metal combustion method, and a melting method. Examples of the production method of wet silica particles (particularly colloidal silica particles) may include a sodium silicate method, an alkoxide method and a sol-gel method. Silica particles produced by any of the production methods are suitably used as the silica particles of the present invention as long as the average particle size (D₅₀) and the circularity of primary particles as defined in the present invention are satisfied. Among these silica particles, dry silica particles are particularly preferred. As the production method thereof, a vaporized metal combustion method and a melting method are preferred.

In an embodiment, the silica particles as a raw material are silica particles obtained by a sodium silicate method. The sodium silicate method is typically a method in which activated silicic acid obtained through ion exchange from an alkali silicate aqueous solution such as water glass is used as raw material and subjected to grain growth.

In an embodiment, the silica particles as a raw material are silica particles obtained by an alkoxide method. The alkoxide method is typically a method in which alkoxysilane is used as raw material and subjected to hydrolytic condensation reaction.

In an embodiment, the silica particles as a raw material are silica particles obtained by a vaporized metal combustion method (VMC method: Vaporized Metal Combustion Method). Vaporized metal combustion method (VMC method) is a method for obtaining silica particles which includes burning a combustion improver (hydrocarbon gas or the like) with a burner in an oxygen-containing atmosphere to form a chemical flame and introducing a metallic silica into the chemical flame in an amount sufficient to form a dust cloud so as to cause vaporized metal combustion.

In an embodiment, the silica particles as a raw material are silica particles obtained by a melting method. The melting method is a method for obtaining silica particles which includes introducing silica into a flame to be melted and then cooling the particles.

The type of silica particles for use is not particularly limited, and for example, surface-modified silica particles may be used. For example, the silica particles may have a cationic group(s). Preferred examples of the silica particles having a cationic group(s) may include silica particles with an amino group(s) immobilized to the surface. Examples of production method of the silica particles having a cationic group(s) may include a method for immobilizing a silane coupling agent having an amino group such as aminoethyl trimethoxy silane, aminopropyl trimethoxy silane, aminoethyl triethoxy silane, aminopropyl triethoxy silane, aminopropyl dimethyl ethoxy silane, aminopropyl methyl diethoxy silane, or aminobutyl triethoxy silane on the surface of abrasive grains as described in Japanese Patent Laid-Open No. 2005-162533. Thereby, the silica particles with an amino group(s) immobilized to the surface (amino group-modified silica particles) can be obtained.

The silica particles may have an anionic group(s). Preferred examples of the silica particles having an anionic group(s) may include silica particles with an anionic group(s) such as a carboxylic acid group(s), a sulfonic acid group(s), a phosphonic acid group(s) or an aluminic acid group(s) immobilized to the surface. A production method of the silica particles having an anionic group(s) is not particularly limited, and examples thereof may include a method for reacting a silane coupling agent having an anionic group at its end with silica particles.

As the specific examples thereof, a sulfonic acid group(s) may be immobilized to silica particles, for example, by a method described in “Sulfonic acid-functionalized silica through of thiol groups”, Chem. Commun. 246-247 (2003). Specifically, silica particles with a sulfonic acid group(s) immobilized to the surface can be obtained by coupling a silane coupling agent having a thiol group(s) such as 3-mercaptopropyl trimethoxy silane with silica particles, and then oxidizing the thiol group(s) with hydrogen peroxide.

Alternatively, in order to immobilize a carboxylic acid group(s) to silica particles, for example, a method described in “Novel Silane Coupling Agents Containing a Photolabile 2-Nitrobenzyl Ester for Introduction of a Carboxy Group on the Surface of Silica Gel”, Chemistry Letters, 3, 228-229 (2000) may be employed. Specifically, silica particles with a carboxylic acid group(s) immobilized to the surface can be obtained by coupling a silane coupling agent containing a photoreactive 2-nitrobenzyl ester with silica particles, and then performing photoirradiation.

An average particle size (D₅₀) of the silica particles as abrasive grains contained in the polishing composition according to the present invention is more than 1.0 μm. Usually, a polishing rate tends to increase with increase in the average particle size of the abrasive grains. Through intensive study of the size of silica particles, the present inventor has surprisingly found that the polishing rate increases approximately in proportion to the average particle size in the range of the average particle size up to 1.0 μm, and strikingly increases in the range exceeding 1.0 μm. With an average particle size (D₅₀) of silica particles of 1.0 μm or less, the polishing rate is insufficient. The average particle size (D₅₀) of silica particles is preferably more than 1.2 μm, more preferably 1.5 μm or more, and particularly preferably 1.8 μm or more. The average particle size (D₅₀) of silica particles is preferably 20 μm or less, more preferably less than 10.0 μm, and particularly preferably less than 7.0 μm. In particular, with an average particle size (D₅₀) of silica particles of less than 10.0 μm (particularly less than 7.0 μm), residual abrasive grains can be more effectively reduced while maintaining a high polishing rate. The average particle size (D₅₀) of silica particles is preferably more than 1.2 μm and 20 μm or less, more preferably 1.5 μm or more and less than 10.0 μm, and particularly preferably 1.8 μm or more and less than 7.0 μm. Within the range, the polishing rate of an object to be polished (in particular, an object to be polished containing a resin and a filler) can be improved. Further, the residual abrasive grains on the surface after polishing of an object to be polished (in particular, an object to be polished containing a resin and a filler) can be reduced, so that compatibility between improvement of the polishing rate and reduction of the residual abrasive grains can be achieved with good balance. Further, within the range, a smaller particle size is suitable for reducing residual abrasive grains, and a larger particle size is suitable for improving the polishing rate. The average particle size (average secondary particle size) of silica particles is a particle size (D₅₀) indicating a 50% cumulative frequency from the small-particle-size end in a volume-based particle size distribution. Here, the average particle size (D₅₀) of silica particles can be determined by a dynamic light scattering method, a laser diffraction method, a laser scattering method, a pore electrical resistance method or the like. Specifically, the value determined by the measurement method described in the following Examples is employed.

The silica particles as abrasive grains contained in the polishing composition according to the present invention have a circularity of primary particles (hereinafter, also referred to simply as “circularity”) of 0.90 or more. If the silica particles have a circularity of primary particles of less than 0.90, the silica particles stick in the surface of an object to be polished during polishing due to irregularities on the surface of the abrasive grains, so that residual abrasive grains on the surface increases excessively after polishing (the following Comparative Examples 1 to 3). The silica particles have a circularity of primary particles of preferably 0.92 or more, more preferably 0.95 or more, and particularly preferably more than 0.95. For example, the silica particles have a circularity of primary particles of preferably 0.92 or more and 1.00 or less, more preferably 0.95 or more and 1.00 or less, and particularly preferably more than 0.95 and 1.00 or less. Within the range, the polishing rate of an object to be polished (in particular, an object to be polished containing a resin and a filler) can be improved. Further, the residual abrasive grains on the surface after polishing of an object to be polished (in particular, an object to be polished containing a resin and a filler) can be reduced, so that compatibility between improvement of the polishing rate and reduction of the residual abrasive grains can be achieved with good balance. In the present description, the circularity of the primary particles of the silica particles is determined by a method described in the following Examples to give a value down to the third decimal place which is then rounded to the second decimal place. A circularity closer to 1 (1.00) is more approximate to a true sphere. Accordingly, a circularity closer to 1 (1.00) indicates that a ratio of particles approximate to a true sphere is higher in the silica particles. Use of the particles more approximate to a true sphere may allow to easily obtain the effects described above.

In an embodiment, the silica particles have a new Mohs hardness of 5 to 9. Such a hardness allows compatibility between improvement of the polishing rate and reduction of the residual abrasive grains to be achieved with good balance.

One type of silica particles may be used alone, or two or more types thereof may be used in combination.

A concentration (content) of the silica particles in the polishing composition according to the present invention is not particularly limited. In the case of a polishing composition to be directly used as polishing liquid for polishing an object to be polished (typically a polishing liquid in a slurry state, which may be also referred to as working slurry or polishing slurry), the concentration (content) of the silica particles relative to the total mass of the polishing composition is preferably 0.5 mass % or more, more preferably 1 mass % or more, still more preferably more than 1 mass %, and particularly preferably 2 mass % or more. The more the concentration of the silica particles is, the more improved the polishing rate is. Also, the concentration (content) of the silica particles relative to the total mass of the polishing composition is preferably 20 mass % or less, more preferably 15 mass % or less, still more preferably 10 mass % or less, furthermore preferably less than 10 mass %, and particularly preferably 8 mass % or less. Within the range, the occurrence of defects such as residual abrasive grains can be further reduced. For example, the concentration (content) of the silica particles relative to the total mass of the polishing composition is preferably 0.5 mass % or more and 20 mass % or less, more preferably 1 mass % or more and 15 mass % or less, still more preferably more than 1 mass % and 10 mass % or less, furthermore preferably 2 mass % or more and less than 10 mass %, and particularly preferably 2 mass % or more and 8 mass % or less. Within the range, the polishing rate of an object to be polished (in particular, an object to be polished containing a resin and a filler) can be improved. Further, residual abrasive grains on the surface of an object to be polished (in particular, an object to be polished containing a resin and a filler) after polishing can be reduced, so that compatibility between the improvement of the polishing rate and the reduction of the residual abrasive grains can be achieved in good balance. Herein, in the case of using two or more types of silica particles, the concentration (content) of the silica particles means a total amount of all types of silica particles.

A content of silica particles in a polishing composition to be diluted for use in polishing (i.e., concentrate, undiluted liquid for working slurry) is usually 30 mass % or less, and more preferably 25 mass % or less, from the viewpoints of storage stability, filterability and the like. Further, from the viewpoint of taking advantage of a concentrate, the content of abrasive grains is preferably 1 mass % or more, and more preferably 5 mass % or more.

The abrasive grains are substantially composed of silica particles having an average particle size (D₅₀) of more than 1.0 μm and a circularity of primary particles of 0.90 or more (silica particles according to the present invention). Here, “abrasive grains are substantially composed of silica particles according to the present invention” means that a total content of the silica particles contained in a polishing composition relative to the total content of abrasive grains contained in the polishing composition is more than 99 mass % (upper limit: 100 mass %). Preferably, the abrasive grains are composed of the silica particles according to the present invention alone (total content of the silica particles according to the present invention relative to the whole abrasive grains is 100 mass %).

### Dispersing Medium

The polishing composition according to the present invention contains a dispersing medium. The dispersing medium disperses or dissolves each of the components.

It is preferable that the dispersing medium contain water. Further, from the viewpoint of preventing impurities from affecting other components in the polishing composition, it is preferable to use water as pure as possible. Specifically, pure water or ultra-pure water prepared by removing impurity ions through an ion exchange resin and then removing foreign substances through a filter, or distilled water is preferred. Also, as a dispersing medium, an organic solvent or the like may be further included to control dispersibility and the like of other components of the polishing composition.

### pH Adjusting Agent

It is preferable that the polishing composition according to an embodiment of the present invention further contain a pH adjusting agent. Through selection of the type and the amount added, the pH adjusting agent can contribute to adjustment of pH of the polishing composition.

The pH adjusting agent is not particularly limited as long as it is a compound having a pH adjusting function, and a known compound may be used. The pH adjusting agent is not particularly limited as long as it is the one having a pH adjusting function, and examples thereof include an acid and an alkali.

As the acid, any of an inorganic acid and an organic acid may be used. The inorganic acid is not particularly limited, and examples thereof may include sulfuric acid, nitric acid, boric acid, carbonic acid, hypophosphorous acid, phosphorous acid, and phosphoric acid. The organic acid is not particularly limited, and examples thereof may include carboxylic acids such as 1-hydroxyethylidene-1,1-diphophonic acid (HEDP), formic acid, acetic acid, propionic acid, butyric acid, valeric acid, 2-methylbutyric acid, n-hexanoic acid, 3,3-dimethylbutyric acid, 2-ethylbutyric acid, 4-methylpentanoic acid, n-heptanoic acid, 2-methylhexanoic acid, n-octanoic acid, 2-ethylhexanoic acid, benzoic acid, glycolic acid, salicylic acid, glyceric acid, oxalic acid, malonic acid, succinic acid, glutaric acid, adipic acid, pimelic acid, maleic acid, phthalic acid, malic acid, tartaric acid, citric acid and lactic acid, and methane sulfonic acid, ethane sulfonic acid and isethionic acid. Among these, organic acids are preferred, and 1-hydroxyethylidene-1,1-diphophonic acid (HEDP), malic acid, citric acid and maleic acid are more preferred. In the case of using an inorganic acid, nitric acid, sulfonic acid and phosphoric acid are preferred.

The alkali is not particularly limited, and examples thereof may include hydroxides of alkali metal such as potassium hydroxide, ammonia, quaternary ammonium salts such as tetramethylammonium and tetraethylammonium, and amines such as ethylenediamine and piperazine. Among these, potassium hydroxide and ammonia are preferred.

Herein, the pH adjusting agents may be used alone, or in combination of two or more.

A content of the pH adjusting agent is not particularly limited, preferably being an amount allowing the pH value to be controlled in the preferred range described later.

### Redispersing Agent

It is preferable that the polishing composition according to an embodiment of the present invention further contain a redispersing agent (redispersing agent for precipitate of abrasive grains). Use of a redispersing agent allows a polishing composition after storage to be easily redispersed. Accordingly, use of a redispersing agent is advantageous in handling of the polishing composition.

The redispersing agent is not particularly limited as long as it is a compound capable of easily redispersing the polishing composition after storage, and a known compound may be used. Specific examples thereof may include organic redispersing agents such as crystalline cellulose, sodium polyacrylate, polyacrylic acid (PAA), hydroxyethyl cellulose (HEC), polyvinyl pyrrolidone (PVP), polyvinyl alcohol (PVA), polyethylene glycol (PEG); and inorganic redispersing agents such as an alumina sol having an average particle size of less than 1.0 μm (in particular, less than 0.2 μm), a layered silicate, and a silica sol. Among these, organic redispersing agents are preferred, and crystalline cellulose and sodium polyacrylate are more preferred.

Thus, in an embodiment of the present invention, the redispersing agent contains an organic redispersing agent. In an embodiment of the present invention, the redispersing agent contains at least one of crystalline cellulose and sodium polyacrylate. In an embodiment of the present invention, the redispersing agent is at least one of crystalline cellulose and sodium polyacrylate.

Alternatively, at least one phosphorus-containing acid selected from the group consisting of phosphoric acid and a condensate thereof, an organic phosphoric acid, phosphonic acid, and an organic phosphoric acid may be used as the redispersing agent. In the present description, “organic phosphoric acid” refers to an organic compound having at least one phosphoric acid group (—OP(═O)(OH)₂), and “organic phosphonic acid” refers to an organic compound having at least one phosphonic acid group (—P(═O)(OH)₂). Further, in the present description, “phosphoric acid and a condensate thereof, and organic phosphoric acid” are also simply referred to as “phosphoric acid-based acids”, and “phosphonic acid and organic phosphonic acid” are also simply referred to as “phosphonic acid-based acids”.

Specific examples of the phosphorus-containing acid include phosphoric acid (ortho-phosphoric acid), pyrophosphoric acid, tripolyphosphoric acid, tetrapolyphosphoric acid, hexametaphosphoric acid, methyl acid phosphate, ethyl acid phosphate, ethyl glycol acid phosphate, isopropyl acid phosphate, phytic acid (myo-inositol-1,2,3,4,5,6-hexaphosphate), nitrilotris(methylene phosphonic acid) (NTMP), ethylenediamine tetra(methylene phosphonic acid) (EDTMP), diethylenetriamine penta(methylene phosphonic acid), ethane-1,1-diphosphonic acid, ethane-1,1,2-triphosphonic acid, ethane-1-hydroxy-1,1-diphosphonic acid, ethanehydroxy-1,1,2-triphosphonic acid, ethane-1,2-dicarboxy-1,2-diphosphonic acid, and methane hydroxy phosphonic acid. Among these, from the viewpoint of improving balance among the re-dispersibility, polishing rate and etching rate, phosphonic acid-based acids are preferred, organic phosphonic acids are more preferred, and 1-hydroxyethylidene-1,1-diphophonic acid (HEDP), nitrilotris(methylene phosphonic acid) (NTMP), and ethylenediamine tetra(methylene phosphonic acid) (EDTMP) are still more preferred. Herein, the phosphorus-containing acids may be used alone, or in combination of two or more. Alternatively, a phosphorus-containing acid may simultaneously serve as a pH adjusting agent.

Herein, the redispersing agents may be used alone, or in combination of two or more.

A concentration (content) of the redispersing agent in the polishing composition according to the present invention is not particularly limited, and may be appropriately selected depending on the desired redispersion properties of the polishing composition after storage. In the case of a polishing composition to be directly used as polishing liquid for polishing an object to be polished (typically a polishing liquid in a slurry state, which may be also referred to as working slurry or polishing slurry), the concentration (content) of the redispersing agent relative to the total mass of the polishing composition is more preferably 0.1 mass % or more, and still more preferably more than 0.3 mass %. Also, the concentration (content) of the redispersing agent relative to the total mass of the polishing composition is preferably 5 mass % or less, and more preferably 1 mass % or less. For example, the concentration (content) of the redispersing agent relative to the total mass of the polishing composition is preferably 0.1 mass % or more and 5 mass % or less, more preferably more than 0.3 mass % and 5 mass % or less, and still more preferably more than 0.3 mass % and 1 mass % or less. Within the range, the polishing composition after storage may be easily redispersed. Herein, in the case of using two or more redispersing agents, the concentration (content) of the redispersing agent means a total amount of all the redispersing agents.

In the case of a polishing composition to be diluted for use in polishing (i.e., concentrate, undiluted liquid for working slurry), a concentration (content) of the redispersing agent is usually 20 mass % or less, and more preferably 10 mass % or less. From the viewpoint of taking advantage of a concentrate, the content of abrasive grains is preferably 1 mass % or more, and more preferably 3 mass % or more.

### Other Components

The polishing composition according to the present invention may further contain a known component such as abrasive grains other than the ones described above, a chelating agent, a thickener, an oxidizing agent, a dispersing agent, a surface protecting agent, a wetting agent, a surfactant, an anticorrosive (rust inhibitor), an antiseptic agent, and an antifungal agent, within a range not impairing the effect of the present invention. A content of the other components may be appropriately set depending on the purpose of addition.

In an embodiment of the present invention, the polishing composition according to the present invention contains silica particles having an average particle size (D₅₀) of more than 1.0 μm and a circularity of primary particles of 0.90 or more (silica particles according to the present invention), a dispersing medium and a redispersing agent, and at least one of a pH adjusting agent and an antifungal agent.

In an embodiment of the present invention, the polishing composition according to the present invention is substantially composed of silica particles having an average particle size (D₅₀) of more than 1.0 μm and a circularity of primary particles of 0.90 or more (silica particles according to the present invention), a dispersing medium and a redispersing agent, and at least one of a pH adjusting agent and an antifungal agent. Here, “being substantially composed of silica particles according to the present invention, a dispersing medium and a redispersing agent, and at least one of a pH adjusting agent and an antifungal agent” means that the total content of the silica particles, the dispersing medium and the redispersing agent, and the pH adjusting agent and/or the antifungal agent relative to the polishing composition is more than 98.0 mass %, and preferably more than 99.0 mass % (upper limit: 100 mass %). Thus, in the embodiment described above, the polishing composition according to the present invention contains silica particles having an average particle size (D₅₀) of more than 1.0 μm and a circularity of primary particles of 0.90 or more (silica particles according to the present invention), a dispersing medium and a redispersing agent, and at least one of a pH adjusting agent and an antifungal agent, and the total content of the silica particles, the dispersing medium and the redispersing agent, and at least one of the pH adjusting agent and the antifungal agent relative to the polishing composition is more than 98 mass % and less than 100 mass % (preferably, more than 99 mass % and less than 100 mass %), or 100 mass %.

In an embodiment of the present invention, the polishing composition according to the present invention is a polishing composition to be directly used as polishing liquid for polishing an object to be polished (typically a polishing liquid in a slurry state, which may be also referred to as working slurry or polishing slurry), which is composed of silica particles having an average particle size (D₅₀) of more than 1.0 μm and a circularity of primary particles of 0.90 or more (silica particles according to the present invention), a dispersing medium, a redispersing agent, and a pH adjusting agent, and at least one additional component selected from the group consisting of a chelating agent, a thickener, an oxidizing agent, a dispersing agent, a surface protecting agent, a wetting agent, a surfactant, an anticorrosive (rust inhibitor), an antiseptic agent and an antifungal agent, with a content of the additional components relative to the polishing composition being 0 mass %, or more than 0 mass % and 2 mass % or less.

In an embodiment of the present invention, the polishing composition according to the present invention is a polishing composition to be diluted for use in polishing (i.e., concentrate, undiluted liquid for working slurry), which is composed of silica particles having an average particle size (D₅₀) of more than 1.0 μm and a circularity of primary particles of 0.90 or more (silica particles according to the present invention), a dispersing medium, a redispersing agent, and a pH adjusting agent, and at least one additional component selected from the group consisting of a chelating agent, a thickener, an oxidizing agent, a dispersing agent, a surface protecting agent, a wetting agent, a surfactant, an anticorrosive (rust inhibitor), an antiseptic agent and an antifungal agent, with a content of the additional components relative to the polishing composition being 0 mass % or more than 0 mass % and 10 mass % or less.

### pH

In the case of a polishing composition to be directly used as polishing liquid for polishing an object to be polished, the pH of the polishing composition according to the present embodiment is preferably 2.0 or more and 7.0 or less, more preferably more than 2.0 and less than 5.0, and still more preferably 2.5 or more and less than 4.0. Within the above ranges, compatibility between improvement of polishing rate and reduction of residual abrasive grains can be achieved with good balance. In the present description, the pH of the polishing composition is determined by the measurement method described in the following Examples.

In the case of a polishing composition which is diluted for use in polishing (i.e., concentrate), the appropriate pH of the polishing composition is 2.5 or more, preferably more than 2.5, and more preferably 3.0 or more. The appropriate pH of the polishing composition is 7.5 or less, preferably less than 5.5, and more preferably less than 4.5.

### Production Method of Polishing Composition

The production method (preparation method) of the polishing composition is not particularly limited, and for example, a production method including providing silica particles having a specific average particle size and a specific circularity as defined herein, and stirring and mixing the silica particles, a dispersing medium (preferably water), and, optionally a redispersing agent and/or other components may be appropriately employed.

Thus, another embodiment of the present invention relates to a production method of a polishing composition including selecting silica particles having an average particle size (D₅₀) of more than 1.0 μm and a circularity of primary particles of 0.90 or more as abrasive grains, and mixing the silica particles and a dispersing medium. The silica particles, the dispersing medium and the redispersing agent, and the other components are the same as those described in the item <Polishing composition>, and so the description is omitted here.

In an embodiment of the present invention, silica particles having an average particle size (D₅₀) of more than 1.0 μm and a circularity of primary particles of 0.90 or more can be obtained by selecting silica particles satisfying the specific conditions from commercially available silica particles. In an embodiment of the present invention, silica particles having an average particle size (D₅₀) of more than 1.0 μm and a circularity of primary particles of 0.90 or more can be obtained by producing silica particles under conditions that they satisfy the specific conditions. In an embodiment of the present invention, silica particles having an average particle size (D₅₀) of more than 1.0 μm and a circularity of primary particles of 0.90 or more can be obtained by controlling silica particles not satisfying the specific conditions to satisfy the specific conditions. On this occasion, a known control method may be used in the same manner or in an appropriately modified manner. For example, in the case of a vaporized metal combustion method, a method for controlling a particle size, a supply rate, a mixing ratio with oxygen, or the like of metallic silicon may be applied.

The silica particles selected as abrasive grains as defined herein, a dispersing medium (preferably water), and, optionally a redispersing agent and/or other components may be stirred and mixed to produce the polishing composition. On this occasion, an order of mixing the respective components is not particularly limited. For example, in the case where the polishing composition contains silica particles, a dispersing medium and a redispersing agent, the polishing composition may be prepared by: feeding silica particles, a dispersing medium and a redispersing agent collectively, and optionally adding a pH adjusting agent thereto so as to obtain a desired pH; feeding silica particles and a redispersing agent into a dispersing medium, and optionally adding a pH adjusting agent thereto so as to obtain a desired pH; feeding silica particles and a redispersing agent into a dispersing medium in this order, and optionally adding a pH adjusting agent thereto so as to obtain a desired pH; feeding a redispersing agent and silica particles into a dispersing medium in this order, and optionally adding a pH adjusting agent thereto so as to obtain a desired pH, or the like. A temperature at which the respective components are stirred and mixed is not particularly limited, and preferably 10 to 40° C. Heating may be performed to increase a dissolution rate. A mixing time is also not particularly limited.

### Object to be Polished

An object to be polished by the polishing composition according to the present invention is not particularly limited. It is preferable that the object to be polished contains a resin and a filler. Thus, in a preferred embodiment of the present invention, the polishing composition is used to polish an object to be polished containing a resin and a filler. When the polishing composition according to the present invention including the specific silica particles as defined above as abrasive grains is used for polishing an object to be polished containing a resin and a filler, polishing proceeds so that the filler and the resin around the filler are peeled off at the same time, and thus a specifically high polishing rate can be obtained in comparison with other abrasive grains for polishing. Further, in the case of polishing a portion of resin containing a filler and a portion of metal such as copper at the same time, the abrasive grains can be suppressed or prevented from sticking into a metal surface (damage to the metal can be suppressed or prevented). Thus, the residual abrasive grains on the surface after polishing can be reduced. Accordingly, in polishing of an object to be polished containing a resin and a filler, the compatibility between high polishing rate and reduction of residual abrasive grains on a surface after polishing can be achieved. On the other hand, when alumina particles (pulverized alumina particles) generally used as abrasive grains for polishing are used, polishing proceeds so that the filler and the resin are scraped off in sequence from the surface.

Further, in the case of polishing a portion of resin containing a filler and a portion of metal such as copper at the same time, the abrasive grains tend to stick into the portion of metal. Thus, the residual abrasive grains on the surface after polishing tends to increase.

Hereinafter, an embodiment in which an object to be polished contains a resin and a filler will be described in detail, though the present invention is not limited to the following embodiment.

The resin is not particularly limited, and examples thereof may include an acrylic resin such as polymethyl(meth)acrylate, a methylmethacrylate-methylacrylate copolymer, and a urethane(meth)acrylate resin; an epoxy resin; an olefin resin such as ultra-high molecular weight polyethylene (UHPE); a phenol resin; a polyamide resin (PA); a polyimide resin (PI); a polyester resin such as polyethylene terephthalate (PET), polybutylene terephthalate (PBT), and an unsaturated polyester resin; a polycarbonate resin (PC); a polyphenylene sulfide resin; a polystyrene resin such as syndiotactic polystyrene (SPS); a polynorbornene resin; polybenzoxazole (PBO); polyacetal (POM); modified polyphenylene ether (m-PPE); amorphous polyacrylate (PAR); polysulfone (PSF); polyether sulfone (PES); polyphenylene sulfide (PPS); polyether ether ketone (PEEK); polyether imide (PEI); a fluorine resin; and a liquid crystal polymer (LCP). In the present description, “(meth)acrylic acid” refers to acrylic acid or methacrylic acid, or both acrylic acid and methacrylic acid. In the same manner, in the present description, “(meth)acrylate” refers to acylate or methacrylate, or also both of acrylate and methacrylate. Among these, from the viewpoint of processability, a resin having a cyclic molecular structure is preferred. Thus, in a preferred embodiment of the present invention, the resin has a cyclic molecular structure. As the resin having such a cyclic molecular structure, an epoxy resin, a polycarbonate resin, or a polyphenylene sulfide resin is preferably used. The resins may be used alone, or in combination of two or more. Alternatively, the resin may be cured by a curing agent.

A material to constitute the filler is not particularly limited, and examples thereof may include glass, carbon, calcium carbonate, magnesium carbonate, barium sulfate, magnesium sulfate, aluminum silicate, titanium oxide, alumina, zinc oxide, silica (silicon dioxide), kaolin, talc, glass beads, sericite active white clay, bentonite, aluminum nitride, polyester, polyurethane and rubber. Among these, from the viewpoint of processability, glass and silica are preferred, and silica is particularly preferred.

Examples of a shape of the filler may include a powder form, a spherical form, a fiber form and a needle form. Among these, a spherical form and a fiber form are preferred, and a spherical form is more preferred from the viewpoint of processability. A size of the filler is not particularly limited. For example, in the case of filler in a spherical form, the average particle size is, for example, 0.01 to 50 μm, and preferably 1.0 to 6.5 μm. For the average particle size, 200 fillers are selected at random from an image of an object to be polished photographed by a scanning electron microscope (SEM) (product name: SU8000, manufactured by Hitachi High-Tech Corporation), to measure each of the particle size, and the average thereof is presumed to be the average particle size. In the case of filler in a fiber form, the average major diameter is for example, 100 to 300 μm, and preferably 150 to 250 μm, and the average minor diameter is for example, 1 to 30 μm, and preferably 10 to 20 μm. Here, 200 fillers are selected at random from an image of an object to be polished photographed by a scanning electron microscope (SEM) (product name: SU8000, manufactured by Hitachi High-Tech Corporation), to measure each of the major diameter and each of the minor diameter, respectively, and the averages thereof are presumed to be the average major diameter (μm) and the average minor diameter (μm), respectively.

Although any combination of silica particles as abrasive grains and fillers may be employed, it is preferable that the size (average particle size) of silica particles as abrasive grains be larger than the size (average particle size) of the fillers. Thus, in preferred embodiment of the present invention, in the case where an object to be polished contains a resin and a filler, the average particle size (D₅₀) of the silica particles as abrasive grains is larger than the average particle size of the filler. In the embodiment, although the relation between the size of silica particles and the size of filler is not particularly limited, a ratio of the average particle size (D₅₀) of the abrasive grains to the average particle size of the filler is preferably more than 1 and 15 or less, more preferably 1.5 or more and less than 10.0, and still more preferably more than 1.6 and less than 7.0. In the above, the average particle size of filler means an average particle size for spherical filler, and an average minor diameter for fibrous filler.

The fillers may be used alone, or in combination of two or more.

Further, the object to be polished may contain a material different from the resin and filler in a surface to be polished in addition to them. Examples of the material may include copper (Cu), aluminum (Al), tantalum (Ta), tantalum nitride (TaN), titanium (Ti), titanium nitride (TiN), nickel (Ni), ruthenium (Ru), cobalt (Co), tungsten (W) and tungsten nitride (WN).

The object to be polished may be prepared from a resin and a filler, or may be prepared from a commercial product. Examples of the commercial product may include interlayer insulation materials “Ajinomoto Build-up Film” (ABF) GX13, GX92, GX-T31 and GZ41 (all manufactured by Ajinomoto Fine-Techno Co., Inc.); a polycarbonate (PC) resin “Panlite (registered trademark)”, glass fiber reinforced grade (both manufactured by Teijin Limited); and GF reinforced Durafide (registered trademark) PPS, and GF inorganic filler reinforced Durafide (registered trademark) PPS (both manufactured by Polyplastics Co., Ltd.).

### Polishing Method

Another embodiment of the present invention relates to a polishing method including a step of polishing an object to be polished with the polishing composition. Preferred examples of the object to be polished according to the present embodiment are the same described in <Object to be polished>. For example, it is preferable to polish an object to be polished containing a resin and a filler in a surface to be polished. Thus, the preferred embodiment of the polishing method according to the present invention includes a step of polishing an object to be polished containing a resin and a filler with the polishing composition.

Polishing an object to be polished with the polishing composition may be performed using an apparatus and conditions for use in usual polishing. Examples of the typical polishing apparatus may include a single side polishing machine and a double side polishing machine. In a single side polishing machine, an object to be polished is typically held with a retainer referred to as carrier, and a plate with a polishing pad attached is pressed against one side of the object to be polished and rotated, while the polishing composition is supplied from above, so that the one side of the object to be polished is polished. In a double side polishing machine, an object to be polished is typically held with a retainer referred to as carrier, and surface plates with a polishing pad attached are pressed against opposing surfaces of the object to be polished and rotated in the opposing directions, while the polishing composition is supplied from above, so that both sides of the object to be polished are polished. On this occasion, polishing is performed through a physical action caused by friction between the polishing pad together with the polishing composition and the object to be polished, and through a chemical action on the object to be polished caused by the polishing composition. As the polishing pad, a porous material of nonwoven fabric, polyurethane, suede or the like may be used without particular limitation. It is preferable that the polishing pad be processed such that a polishing liquid is accumulated.

Examples of the polishing conditions may include polishing load, rotation speed of plate, rotation speed of carrier, flow rate of polishing composition, and polishing time. Although these polishing conditions are not particularly limited, for example, a polishing load per unit area of the object to be polished is preferably 0.1 psi (0.69 kPa) or more and 10 psi (69 kPa) or less, more preferably 0.5 psi (3.5 kPa) or more and 8.0 psi (55 kPa) or less, and still more preferably 1.0 psi (6.9 kPa) or more and 6.0 psi (41 kPa) or less. In general, the more the load is, the more the friction force by abrasive grains is, so that the mechanical processing force is improved. As a result, the polishing rate increases. Within the ranges, a sufficient polishing rate can be achieved, while damage to an object to be polished and occurrence of defects such as surface scratches caused by the load can be suppressed. It is preferable that a rotation speed of plate and a rotation speed of carrier be 10 rpm (0.17 s⁻¹) to 500 rpm (8.3 s⁻¹). A supply rate of polishing composition may be a supply rate (flow rate) at which the polishing composition covers the whole of an object to be polished, and may be adjusted depending on the conditions such as the size of the object to be polished. Also, a method for supplying the polishing composition to a polishing pad is not particularly limited, and, for example, a continuous supply method with use of a pump or the like may be employed. Also, although a processing time is not particularly limited as long as desired processing results are obtained, a less time resulting from a high polishing rate is preferred.

Further, another embodiment of the present invention relates to a production method of a polished object, including a step of polishing an object to be polished by the polishing method as defined herein. Preferred examples of the object to be polished according to the embodiment is the same described in <Object to be polished>. As a preferred example, there may be mentioned a production method for an electronic circuit board including polishing an object to be polished including a resin and a metal by the polishing method as defined herein.

### EXAMPLES

The present invention will be described in more detail with the following Examples and Comparative Examples. However, the technical scope of the present invention is not limited only to the following Examples. Herein, “%” and “part” mean “mass %” and “part by mass”, respectively.

### Measurement Method of Physical Property

### Average Particle Size of Silica Particles

Silica particles were subjected to measurement using a particle size distribution measuring apparatus (Microtrac particle size distribution measuring apparatus MT3300EX II, manufactured by MicrotracBEL Corp.), to determine a volume-based particle size distribution. In the resulting particle size distribution, a particle size indicating a 50% cumulative frequency from the small-particle-size end was defined as the average particle size of silica particles (D₅₀). The average particle size of alumina particles was measured in the same manner as described above.

### Circularity of Silica Particle

Silica particles were photographed by a scanning electron microscope (SEM) (product name: SU8000, manufactured by Hitachi High-Tech Corporation), and the resulting SEM image was analyzed using an image analysis software (“WinROOF 2018”, manufactured by Mitani Corporation). In more detail, from the silica particles present in the SEM image, 30 pieces of silica particles were randomly selected as samples for measurement of circularity of each particle (=4 πS/L²; S=Projected area of silica particle, L=Circumference of silica particle). Average thereof was calculated and the average value was defined as the circularity of the silica particles. The circularity of alumina particles was measured in the same manner as described above.

### pH

The pH value of the polishing composition was checked by a pH meter (model number: LAQUA (registered trademark), manufactured by Horiba, Ltd.).

### Examples 1 to 6 and Comparative Examples 1 to 5

Dry silica particles and alumina particles (abrasive grains) described in the following Table 1, crystalline cellulose (redispersing agent), and 1-hydroxyethylidene-1,1-diphosphonic acid (HEDP) (pH adjusting agent) were provided. Into distilled water (dispersing medium), the silica particles or alumina particles (abrasive grains) described in Table 1 were mixed to a content of 2 mass % and the crystalline cellulose (redispersing agent) was mixed to a content of 0.5 mass % in sequence while stirring. Then, pH was adjusted to 3.0 using HEDP (pH adjusting agent), so that a polishing composition was prepared (mixing temperature: about 25° C., mixing time: about 30 minutes). In Example 6, no crystalline cellulose (redispersing agent) was added.

For each of the polishing compositions obtained as described above, a polishing rate and the number of residual abrasive grains on the surface of the object to be polished after polishing were evaluated according to the methods described in the following [Polishing rate (polishing speed)] and [Residual abrasive grains on surface], respectively. The results are shown in the following Table 1. In the following Table 1, a ratio of average particle size (D₅₀) of abrasive grains to average particle size of fillers (“Abrasive grain size/Filler size” in Table 1) is also described.

### Evaluation

### Polishing Rate (Polishing Speed)

As an object to be polished, a mixture of an epoxy resin and a filler (spherical silica, average particle size=1.0 μm) with a filler content of 70 mass % was provided (object to be polished 1, specific gravity: 1.9 g/cm³). A copper substrate was also provided (object to be polished 2). Subsequently, the objects to be polished 1 and 2 (substrates) were polished with each of the polishing compositions at the same time using the following polishing apparatus and polishing conditions. After completion of polishing, a polishing rate (polishing speed) of the objects to be polished was evaluated according to the following (Evaluation method of polishing rate).

### Polishing Apparatus and Polishing Conditions

Polishing apparatus: small-sized table-top polishing machine (EJ380IN, manufactured by Engis Japan Corporation)
Diameter of surface plate: 380 mm
Polishing pad: pad made of rigid polyurethane (IC1010, manufactured by NITTA DuPont Incorporated)
Rotation speed of platen (surface plate): 45 rpm
Rotation speed of head (carrier): 45 rpm
Polishing pressure (polishing load): 4.5 psi (316 g/cm3)
Flow rate of polishing composition: 100 ml/min
Polishing time: 1 min

### Evaluation Method of Polishing Rate

1. Masses of an object to be polished before and after polishing were measured with an analytical balance XS205 (manufactured by Mettler-Toledo International Inc.). From a difference between the masses, a mass change ΔM (kg) of the object to be polished before and after polishing was calculated.
2. The mass change ΔM (kg) of the object to be polished before and after polishing was divided by a specific gravity of the object to be polished (specific gravity of material to be polished), to calculate a volume change ΔV (m³) of the object to be polished before and after polishing.
3. The volume change ΔV (m³) of the object to be polished before and after polishing was divided by an area S (m²) of a surface to be polished of the object to be polished, to calculate a thickness change Δd (m) of the object to be polished before and after polishing.
4. The thickness change Δd (m) of the object to be polished before and after polishing was divided by a polishing time t (min), and the unit was converted to (μm/min). The value was defined as polishing rate v [μm/min]. Although a higher polishing rate is preferred, a polishing rate of 5 μm/min or more is acceptable, and a polishing rate of 9.0 μm/min is desirable.

### Residual Abrasive Grains on Surface

The copper wire surface as an object to be polished after polishing used for evaluation on the polishing rate was photographed by a scanning electron microscope (SEM) (product name: SU8000, manufactured by Hitachi High-Tech Corporation), and the resulting SEM image was analyzed using an image analysis software (“WinROOF 2018” manufactured by Mitani Corporation). In more detail, the number of the abrasive grains (silica particles or alumina particles) present in an area of 110 μm by 110 μm in the SEM image was counted and converted into the number of residual abrasive grains per mm² (pieces/mm²), which was defined as the number of residual abrasive grains on the surface of the object to be polished after polishing. Although a lower number of residual abrasive grains on the surface of the object to be polished after polishing (pieces/mm²) is preferred, 1000×10³ pieces/mm² or less is acceptable, less than 600×10³ pieces/mm 2 is desirable, and less than 100×10³ pieces/mm² (“<100” in Table 1) is particularly desirable. In the following Table 1, the number of residual abrasive grains (pieces/mm²) on the surface of an object to be polished after polishing is described as “Number of residual abrasive grains on surface (×10³ pieces/mm²)”.

TABLE 1

| | Abrasive grains | | | | | | Crystalline | | | |
|---|---|---|---|---|---|---|---|---|---|---|
| | | Average | | | Abrasive | Amount | cellulose | | Polishing | Residual abrasive |
| | | particle size | | New Mohs | grain size/ | added | Amount added | | rate | grains on surface |
| | Material | [μm] | Circularity | hardness | Filler size | [mass %] | [mass %] | pH | [μm/min] | [×10³ pieces/mm²] |
| Example 1 | Silica | 1.8 | 0.96 | 7 | 1.8 | 2 | 0.5 | 3.0 | 9.0 | <100 |
| Example 2 | Silica | 2.1 | 0.97 | 7 | 2.1 | 2 | 0.5 | 3.0 | 14.1 | <100 |
| Example 3 | Silica | 2.6 | 0.95 | 7 | 2.6 | 2 | 0.5 | 3.0 | 15.3 | <100 |
| Example 4 | Silica | 6.4 | 0.96 | 7 | 6.4 | 2 | 0.5 | 3.0 | 26.3 | 527 |
| Example 5 | Silica | 10.5 | 0.96 | 7 | 10.5 | 2 | 0.5 | 3.0 | 25.3 | 864 |
| Example 6 | Silica | 1.8 | 0.96 | 7 | 1.8 | 2 | — | 3.0 | 9.0 | <100 |
| Comparative | Alumina | 0.7 | 0.68 | 12 | 0.7 | 2 | 0.5 | 3.0 | 0.3 | 8018 |
| Example 1 | | | | | | | | | | |
| Comparative | Alumina | 1.2 | 0.67 | 12 | 1.2 | 2 | 0.5 | 3.0 | 2.0 | 5500 |
| Example 2 | | | | | | | | | | |
| Comparative | Alumina | 2.8 | 0.63 | 12 | 2.8 | 2 | 0.5 | 3.0 | 7.6 | 9191 |
| Example 3 | | | | | | | | | | |
| Comparative | Silica | 0.6 | 0.96 | 7 | 0.6 | 2 | 0.5 | 3.0 | 0.3 | <100 |
| Example 4 | | | | | | | | | | |
| Comparative | Silica | 0.8 | 0.97 | 7 | 0.8 | 2 | 0.5 | 3.0 | 0.5 | <100 |
| Example 5 | | | | | | | | | | |

As shown in Table 1, use of the polishing composition according to the present invention enables the compatibility between high polishing rate (polishing speed) and smaller number of residual abrasive grains to be achieved. On the other hand, in the case of using the polishing compositions in Comparative Examples 1 to 3 with use of alumina particles as abrasive grains, the results were poor at least in terms of the number of residual abrasive grains. Further, in the case of using the polishing compositions in Comparative Examples 4 and 5 containing silica particles having a circularity within the scope of the present invention and an average particle size out of the scope of the present invention as abrasive grains, the resulting polishing rate (polishing speed) was significantly inferior, though the number of residual abrasive grains was sufficiently low.

The polishing composition in Example 6 and the polishing composition in Example 1 have the same composition except for the redispersing agent, and the polishing rate and the number of residual abrasive grains are the same. Although the polishing compositions with the redispersing agent added in Examples 1 to 5 left still in a bottle cause solid-liquid separation due to sedimentation of silica particles (abrasive grains), the precipitates of abrasive grains are easily loosened and dispersed into the liquid part when the bottle is rolled over. On the other hand, after the polishing composition left still in a bottle causes solid-liquid separation due to sedimentation of silica particles (abrasive grains), the precipitates of abrasive grains are not easily loosened and hardly dispersed into the liquid part even when the bottle is rolled over. These results show that the redispersing agent has excellent effect on the handling of the polishing composition, without influence on the polishing performance such as the polishing rate (polishing speed) and the number of residual abrasive grains.

The present application is based on Japanese patent application No. 2021-033188 filed on Mar. 3, 2021, and a disclosed content thereof is incorporated herein as a whole by reference.

1. A polishing composition comprising abrasive grains and a dispersing medium, wherein the abrasive grains are silica particles having an average particle size (D₅₀) of more than 1.0 μm and a circularity of primary particles of 0.90 or more.

2. The polishing composition according to claim 1, further comprising a redispersing agent.

3. The polishing composition according to claim 1, wherein the polishing composition is used for polishing an object to be polished containing a resin and a filler.

4. The polishing composition according to claim 3, wherein the silica particles have an average particle size (D₅₀) larger than an average particle size of the filler.

5. The polishing composition according to claim 4, wherein a ratio of the average particle size (D₅₀) of the silica particles to the average particle size of the filler is more than 1 and or less.

6. A method for producing a polishing composition comprising selecting silica particles having an average particle size (D₅₀) of more than 1.0 μm and a circularity of primary particles of 0.90 or more as abrasive grains, and mixing the silica particles and a dispersing medium.

7. A polishing method comprising polishing an object to be polished containing a resin and a filler by using the polishing composition according to claim 1.

8. The method according claim 7, wherein the resin has a cyclic molecular structure.
